(19) United States
(12) Patent Application Publication
(10) Pub. No.: US 2016/0102862 A1
(43) Pub. Date: Apr. 14, 2016

(54) METHOD FOR MANUFACTURING A MACHINE COMPONENT

(71) Applicant: Solar Turbines Incorporated, San Diego, CA (US)

(72) Inventors: ALEXANDER I. KRICHEVER, Carlsbad, CA (US); Ariel Schuger, La Mesa, CA (US); Leonel Arellano, Poway, CA (US); Diane K. Larue, San Diego, CA (US); Oscar T. Lopez, San Ysidro, CA (US)

(73) Assignee: Solar Turbines Incorporated, San Diego, CA (US)

(21) Appl. No.: 14/509,403

(22) Filed: Oct. 8, 2014

(51) Int. Cl. F23R 3/28; H01Q 1/28; C23C 26/02; B23K 26/34; B22D 25/00; B05D 3/00

(52) U.S. Cl. CPC F23R 3/28; B22D 25/005; B05D 3/007; C23C 26/02; B23K 26/345; H01Q 1/28

(57) ABSTRACT

A method for manufacturing a machine component includes obtaining a casted component, a forged component, or a component manufactured using additive fabrication such that the machine component has a wall exhibiting at least some porosity therethrough. The method further includes adding a filler material to on the wall to a pre-determined thickness, the filler material being configured to cover the porosity present in the wall. The method further includes finishing the component by performing a finishing operation.

### TECHNICAL FIELD

The present disclosure relates to a machine component and a method for manufacturing the same.

### BACKGROUND

Components formed from manufacturing processes such as casting or forging may typically exhibit some degree of porosity which may adversely affect a performance of such components. For example, swirlers used for mixing a supply of air and fuel in gas turbine engines are often formed from casting and such cast swirlers are typically known to exhibit porosity.

U.S. Pat. No. 7,066,235 (hereinafter referred to as the '235 patent) relates to a method for manufacturing a clad component. However, manufacturing methods such as that disclosed in the '235 patent have not been known to address the concerns of porosity in casted or forged components.

Hence, there is a need for a method of manufacturing machine components with little or no porosity.

### SUMMARY OF THE DISCLOSURE

In one aspect of the present disclosure, a method for manufacturing a machine component includes obtaining at least one of a casted component, a forged component, or a component manufacturing using additive fabrication, the component having a wall possibly exhibiting at least some porosity therethrough. The method further includes adding a filler material to on the wall to a pre-determined thickness, the filler material configured to cover the porosity present in the wall. The method further includes finishing the component by performing a finishing operation on the filler material.

In another aspect, embodiments of the present disclosure disclose forming a recess in the wall and filling the recess with the filler material using a laser cladding operation.

Further, embodiments of the present disclosure are directed to a machine component manufactured using the methods disclosed herein.

Furthermore, embodiments of the present disclosure are also directed to a gas turbine engine and an aviation vehicle employing machine components that are manufactured using the methods disclosed herein.

Other features and aspects of this disclosure will be apparent from the following description and the accompanying drawings.

### BRIEF DESCRIPTION OF THE DRAWINGS

FIG. 1 is a side sectional view of an exemplary gas turbine engine employing various machine components manufactured in accordance with an embodiment of the present disclosure;

FIG. 2 is a perspective view of an exemplary machine component that is obtained from casting;

FIG. 3 is a diagrammatic cross sectional representation of the exemplary machine component taken along section X-X′ of FIG. 2, the exemplary machine component exhibiting porosity therein;

FIG. 4 is a diagrammatic representation of the exemplary machine component showing a recess formed therein;

FIG. 5 is a diagrammatic representation of the exemplary machine component showing a filler material provided in the recess of the exemplary machine component;

FIG. 6 is a diagrammatic representation of the exemplary machine component after performing a finishing operation; and

FIGS. 7-8 are flowcharts illustrating methods of manufacturing a machine component that is consistent with various embodiments of the present disclosure.

### DETAILED DESCRIPTION

Wherever possible, the same reference numbers will be used throughout the drawings to refer to same or like parts. Moreover, references to various elements described herein are made collectively or individually when there may be more than one element of the same type. However, such references are merely exemplary in nature. It may be noted that any reference to elements in the singular is also to be construed to relate to the plural and vice-versa without limiting the scope of the disclosure to the exact number or type of such elements unless set forth explicitly in the appended claims.

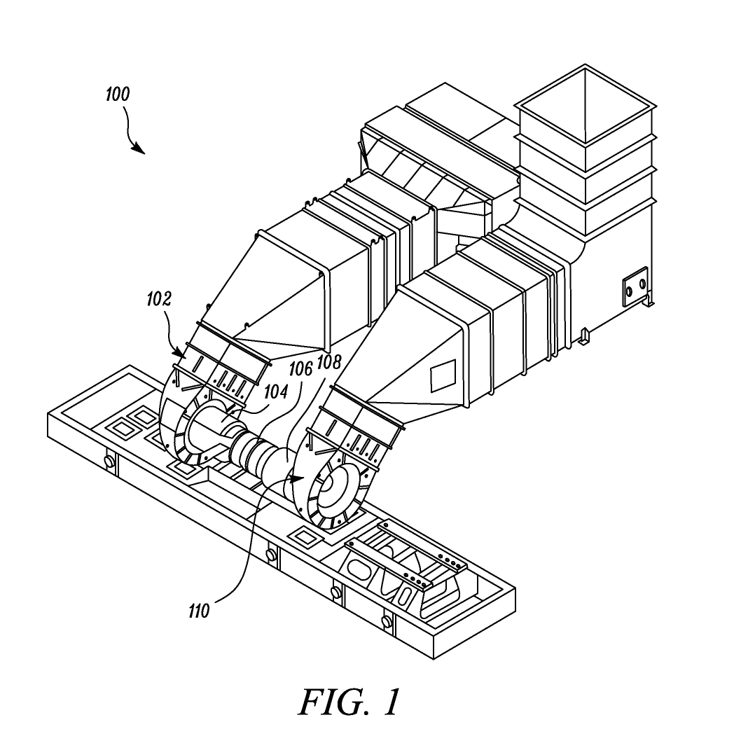

FIG. 1 shows a side sectional view of an exemplary gas turbine engine 100 employing various machine components manufactured in accordance with an embodiment of the present disclosure. Although a gas turbine engine is disclosed herein, in alternative embodiments, other types of engines known in the art may be suitably employed in lieu of the gas turbine engine 100 of FIG. 1. Some examples of engines that may be optionally used in place of the gas turbine engine 100 may include, but are not limited to, a reciprocating engine, a rotary engine or any other type of engine commonly known in the art.

Besides engines, the present disclosure may also be implemented in other structures typically used in various industrial applications. For example, the structures may be casted or forged components or components that are made using other manufacturing technologies, such as, but not limited to, additive fabrication. Such structures may be static or dynamic structures depending upon the associated application and intended area of use. Therefore, although the present disclosure is explained in conjunction with the gas turbine engine 100, one of ordinary skill in the art will acknowledge that embodiments of the present disclosure can be similarly applied to or implemented with other suitable structures known in the art.

Referring to FIG. 1, the gas turbine engine 100 includes an inlet system 102, a compressor system 104, a combustor system 106, a turbine system 108, and an exhaust system 110. The inlet system 102 is configured to supply air to the compressor system 104. The compressor system 104 may compress the supplied air and operatively provide the compressed air to various components of the combustor system 106 and the turbine system 108, the compressed air also serving purposes in the gas turbine engine 100 such as, but not limited to, venting, and escaping through the exhaust system 110. The compressor system 104 may be, but not limited to, a rotary compressor. Further, the compressor system 104 may be a single stage or a multistage compressor. As shown in FIG. 1, the compressor system 104 may embody a multistage rotary compressor.

The combustor system 106 may include multiple injectors, and combustors (not shown) operatively connected to the injectors. The injectors may supply a mixture of fuel and air to the combustors. The combustors combust the mixture of fuel and air to generate energy. This energy may be utilized to drive the turbine system 108 which may in turn use some part of the energy in driving the compressor system 104 while concurrently using the remaining part of the energy to do work.

The exhaust system 110 is coupled to the turbine system 108. Moreover, the exhaust system 110 is configured to draw exhaust gases from the turbine system 108 into the atmosphere. The present disclosure relates to a method for manufacturing a machine component that can be employed by the gas turbine engine of FIG. 1. More particularly, the present disclosure relates to a method for manufacturing a machine component that exhibits porosity, wherein such method is configured to minimize the porosity of the machine component.

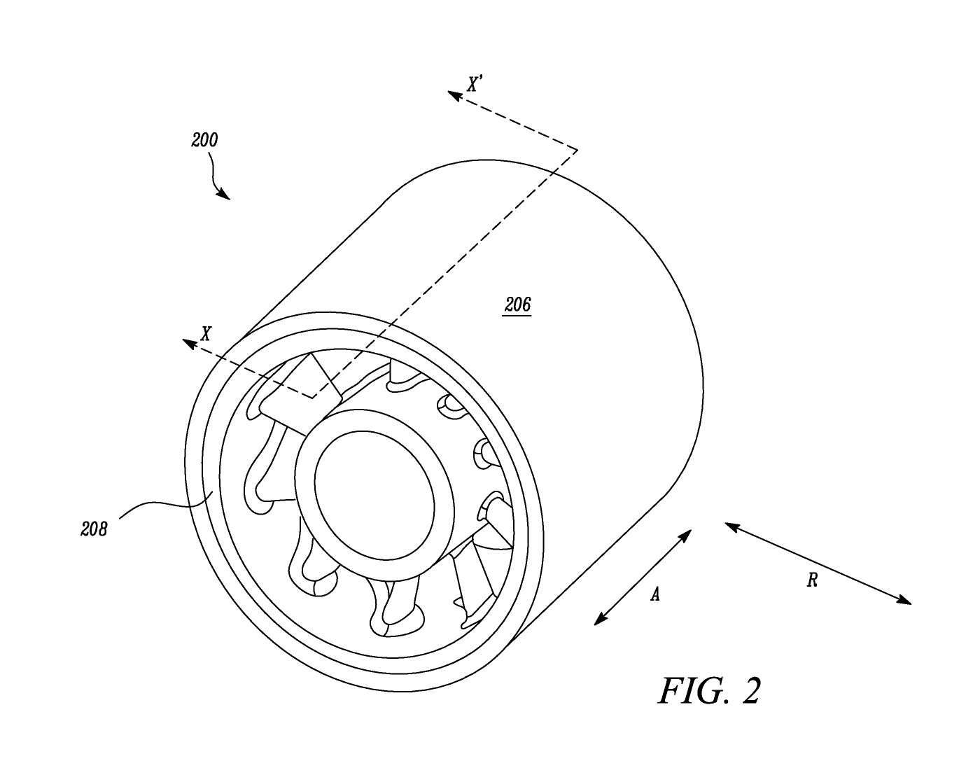

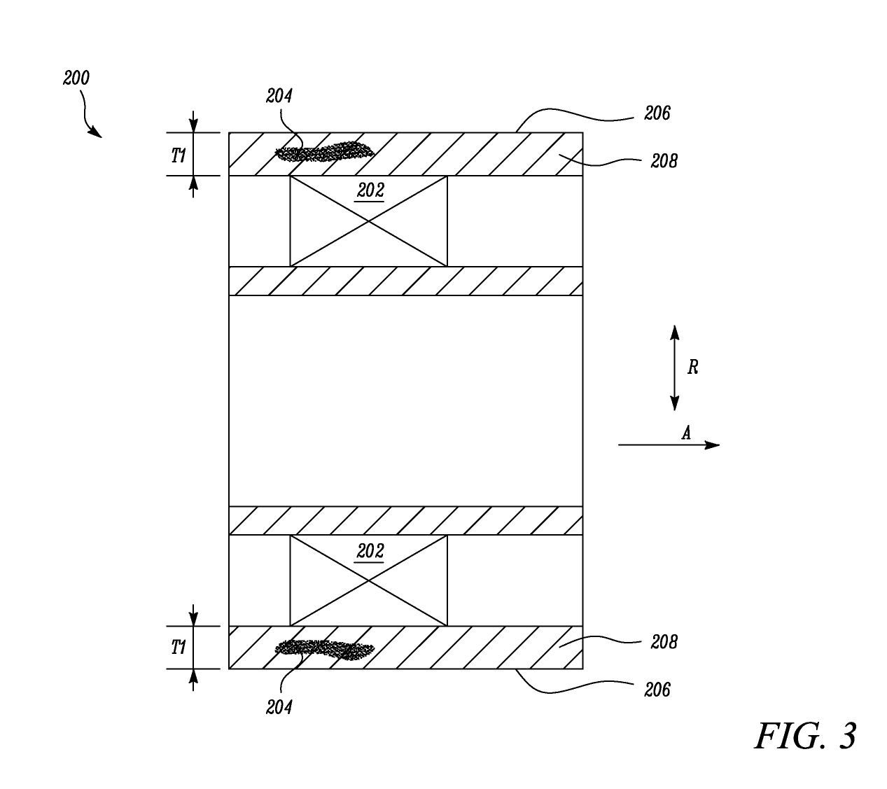

FIG. 2 illustrates a machine component 200 that is obtained from casting. FIG. 3 illustrates a cross-section of the machine component 200 taken along sectional line X-X′ of FIG. 2. In an embodiment as shown in FIGS. 2 and 3, the machine component 200 may be formed into a swirler using embodiments of the present disclosure such that the swirler is configured for use in mixing and delivering air and fuel to the combustors present in the combustor system 106 of the gas turbine engine 100 (See FIG. 1). As best shown in the diagrammatic representation of FIG. 3, the swirler may include vanes 202 that help facilitate mixing of the air and fuel in the axial and the radial directions A, R.

For purposes of clarity in understanding the and ease of understanding the present disclosure, the machine component 200 may hereinafter be sometimes referred to as ‘the swirler’ and designated with the same reference numeral ‘200’. However, one of ordinary skill in the art will appreciate that embodiments of the present disclosure can be similarly applied to any type of machine component without deviating from the spirit of the present disclosure.

Although explanation to the present disclosure is hereinafter made in conjunction with the swirler that is designated with the same reference numeral ‘200’, the machine component 200 disclosed herein may embody other types of machine components or parts that are typically used in or associated with other industrial applications. In an aspect of the present disclosure, it is envisioned that antenna guides that are typically used in aviation vehicles may also benefit from being manufactured using the methods disclosed herein as they experience some or more degree of porosity therein when being manufactured using conventional methods. Hence, it may be noted that the swirler disclosed herein should only be taken in the explanatory and illustrative sense, and should not be construed as being limiting of the present disclosure.

Referring to FIG. 3, the machine component i.e., swirler 200 may be obtained from casting. However, in other cases where other types of machine components are used in the gas turbine engine 100 of FIG. 1, the machine component/s 200 may also be obtained from forging or additive fabrication depending on specific requirements of the application. Components typically obtained from manufacturing processes such as, but not limited to, casting, forging, additive fabrication, and the like may exhibit some degree of porosity therein. As such, with reference to FIG. 3, the machine component 200 as obtained from casting exhibits some porosity thereon (as indicated by the presence of pores 204 in a wall 208 of the machine component 200 in FIG. 3). Specifically, these pores 204 extend at least partly through the wall 208 of the machine component 200, as best seen in the diagrammatic representation of FIG. 3.

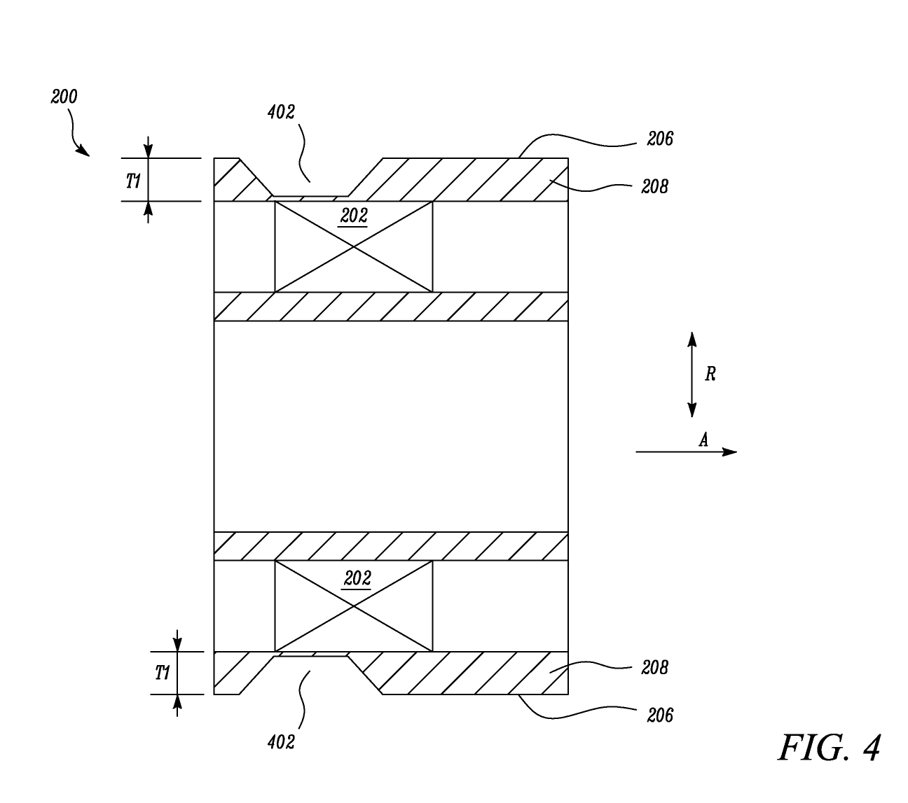

Referring to FIG. 4, the machine component 200 is shown at an instant, after a recess 402 is formed in the wall 208 of the machine component 200. As shown, the recess 402 is located on the wall 208 where porosity was present (See FIG. 2). The recess 402 is formed and configured so as to extend partway through a thickness T1 of the wall 208. Moreover, as shown in the illustrated embodiment of FIG. 4, the recess 402 is shaped into a groove to correspond with the locations of porosity on the machine component 200 (See FIG. 3). The groove may be formed in the wall 208 by performing a machining operation on the outer surface 206 of the wall 208 and hence, reducing the thickness T1 of the wall 208 at the locations where porosity is present.

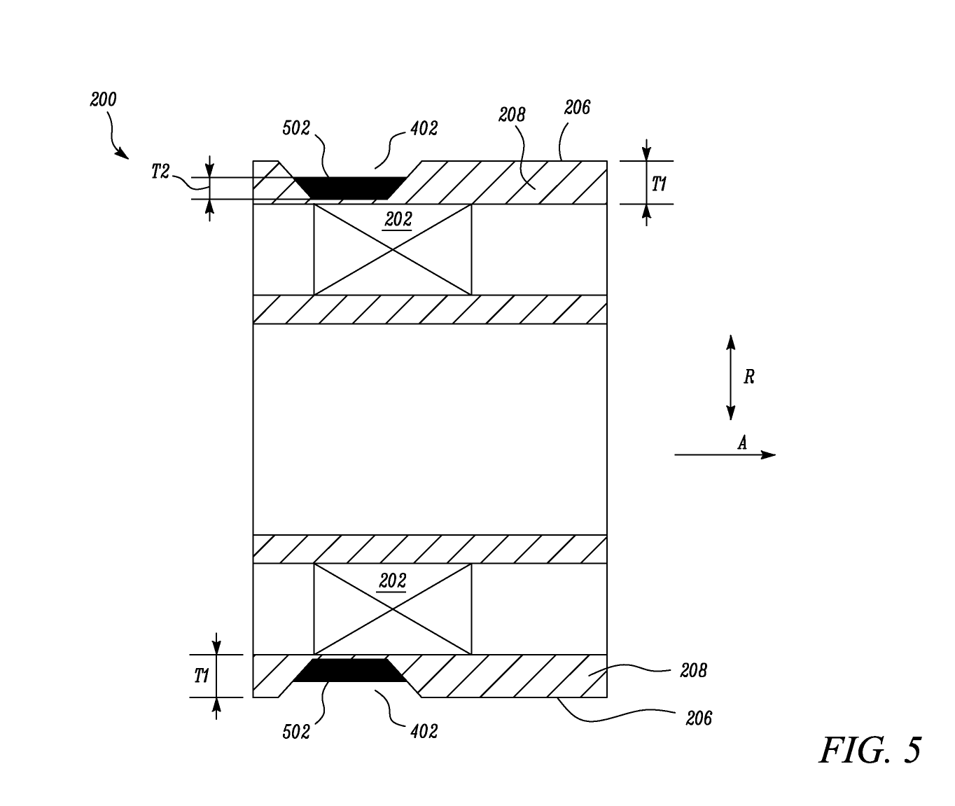

FIG. 5 illustrates a diagrammatic representation of the exemplary machine component 200, the machine component 200 shown with a filler material 502 being provided in the recess 402 formed thereon. In an embodiment as shown in FIG. 5, the filler material 502 may be bonded onto the machine component 200 by performing a laser cladding operation at the recess 402. The filler material 502 may be laser cladded to a pre-determined thickness T2 depending on specific requirements of an application.

Although in the preceding embodiment, it has been disclosed that the filler material 502 is laser cladded upon forming the recess 402 in the wall 208 at locations exhibiting porosity (as defined by the presence of pores 204 in FIG. 3); it may be noted that the present disclosure is not limited thereto. In various embodiments of the present disclosure, the filler material 502 may be directly added onto the wall 208 of the machine component 200 without creating or forming the recess 402 therein. The filler material 502 being added without the recess 402 is also similarly configured to cover the porosity present in the wall 208 of the machine component 200.

Moreover, although such recess 402 is disclosed herein as being formed by performing a turning process after obtaining the casted or forged machine component 200, may alternatively be formed during the casting, forging, or additive fabrication stage of the machine component 200 itself. Therefore, it will be appreciated that although various structural elements and/or features of the machine component 200, for e.g., the recess 402, are disclosed herein as being obtained by performing a turning, milling, or grinding operation on the wall of the machine component 200, it can also be contemplated to form such structural elements and/or features by other processes commonly known to one skilled in the art.

With continued reference to FIG. 5, a type of filler material 502 used in the recess may be similar to a material of the machine component 200. For example, if the machine component 200 is formed from cast or forged Stainless Steel (SS), then the filler material 502 used at the recess 402 may beneficially be made up of Stainless Steel (SS). In another example, if the machine component 200 is formed from casting a metal such as, for e.g., Hastelloy-X, then the filler material 502 used at the recess 402 may beneficially be made up of Hastelloy-X. This way, the filler material 502 may be configured with properties that are similar to that of the machine component 200 and hence, form a unitary component together with the machine component 200. However, one of ordinary skill in the art will appreciate that dissimilar materials may also be laser cladded onto the machine component 200 and used as the filler material 502 depending on specific requirements of an application.

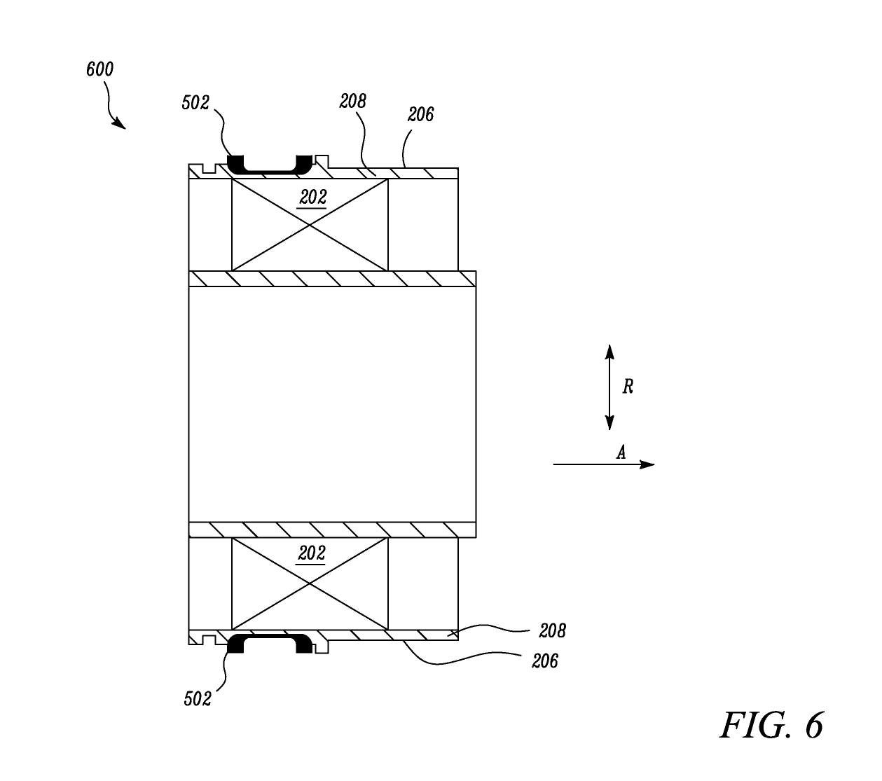

FIG. 6 illustrates a diagrammatic representation of the exemplary machine component 600 after performing a finishing operation. As shown in FIG. 6, the machine component 600 has been obtained after performing a finishing operation that includes at least one machining operation on the filler material 502. However, in the illustrated embodiment of FIG. 6, in addition to performing such process on the filler material 502, the outer surface 206 of the machine component 200 (See FIGS. 2-5) may be optionally turned, or subject to other types of machining processes to obtain the finished machine component 600.

Although turning and other machining operations have been disclosed herein, one of ordinary skill will acknowledge that the turning operation is merely exemplary in nature and hence, non-limiting of this disclosure. Numerous other finishing processes such as, but not limited to, grinding, are readily known to one skilled in the art and such finishing processes be suitably employed in lieu of the turning operation to obtain the finished machine component 600 of FIG. 6.

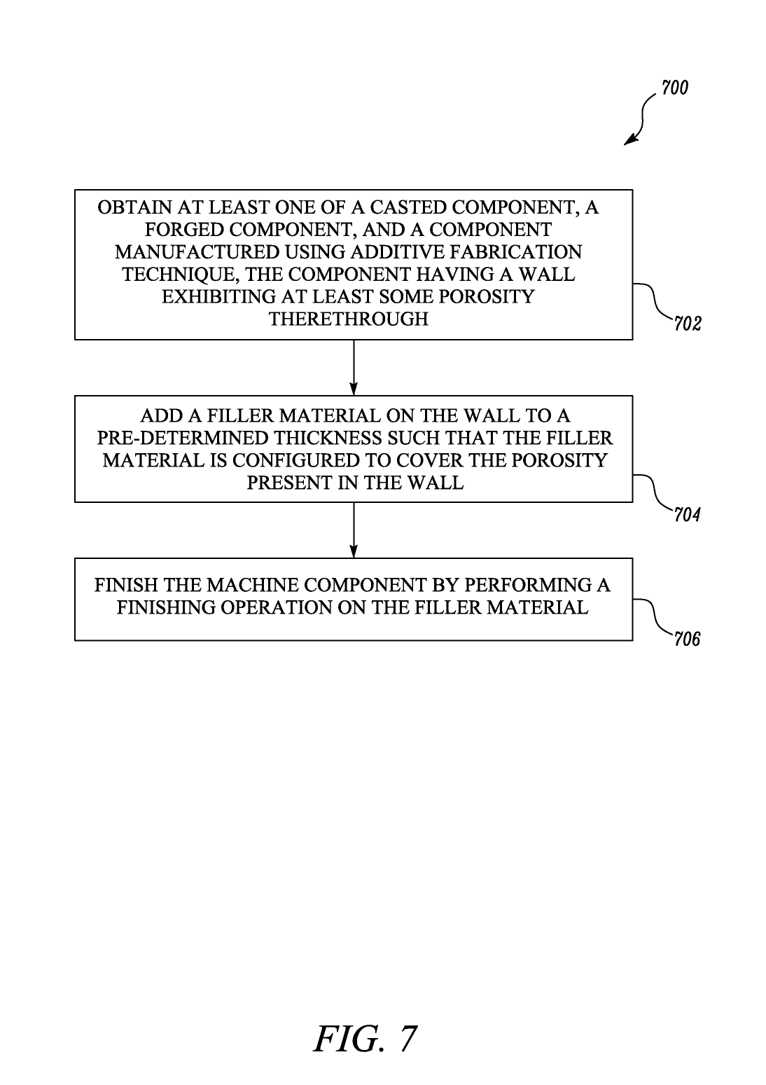

FIG. 7 illustrates a method 700 of manufacturing a machine component 600 in accordance with an embodiment of the present disclosure. At step 702, the method 700 includes obtaining at least one of a casted component, a forged component, and a component manufactured using additive fabrication process, wherein the wall 208 of the component 200 exhibits at least some porosity therethrough.

At step 704, the method 700 further includes adding the filler material 502 on the wall 208 to the pre-determined thickness T2. In various embodiments of the present disclosure, it has been disclosed that the recess 402 is formed prior to filling the recess 402 with the filler material 502. However, not withstanding anything in this document or otherwise, the filler material 502 may be added directly onto the wall 208 of the machine component 200, i.e., at its outer surface 206 without creating or forming a recess 402.

The pre-determined thickness T2 of the filler material 502 in the recess 402 of the machine component 200 may vary from one type of machine component to another and may also vary depending on specific requirements of an application.

Moreover, as disclosed earlier herein, the filler material 502 may preferably be of a material that is similar to that of the machine component 200. For example, if the machine component 200 is formed from cast or forged Stainless Steel (SS), then the filler material 502 may be made up of Stainless Steel (SS). In another example, if the machine component 200 is formed from cast Hastelloy-X, then the filler material 502 may be made up of Hastelloy-X. This way, the filler material 502 may be configured with properties similar to that of the machine component 200 and hence, form a unitary component together with the machine component 200. However, as disclosed earlier herein, dissimilar materials may optionally be used to form the laser cladded filler material 502 depending on specific requirements of an application, for e.g., to improve thermal conductivity, thermal expansion, or strength of the machine component 200.

At step 708, the method 700 further includes finishing the component 200 by performing a finishing operation. Various types of finishing operations such as, but not limited to, machining may be performed on the filler material 502 and/or the outer surface of the machine component 200. Although machining operation is disclosed herein, one of ordinary skill will acknowledge that the machining operation is merely exemplary in nature and hence, non-limiting of this disclosure. Numerous other finishing processes such as, but not limited to, grinding, are readily known to one skilled in the art and such finishing processes be suitably employed in lieu of the machining operation to obtain the finished machine component 600 of FIG. 6. Such finishing operations are performed on the filler material 502 and/or other portions of the machine component 200, for e.g., the outer surface 206 to bring the machine component 200 to final dimensional specifications, i.e., as shown by way of the machine component 600 in the illustrated embodiment of FIG. 6.

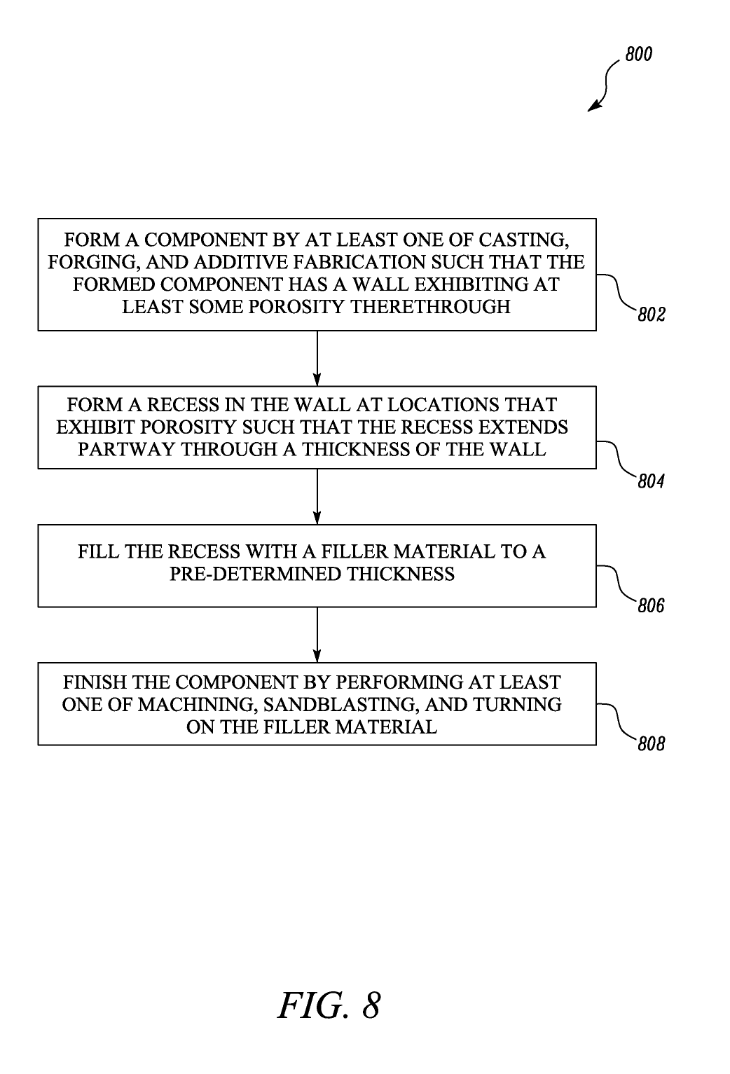

FIG. 8 illustrates a method 800 of manufacturing the machine component 600 in accordance with another embodiment of the present disclosure. At step 802, the method 800 includes forming the machine component 200 by at least one of casting, forging, and additive fabrication, wherein the formed machine component 200 exhibits at least some porosity therethrough. At step 804, the method 800 further includes forming the recess 402 in the wall 208 at locations that exhibit porosity. The recess 402 may be formed and configured to extend partway through the thickness T1 of the wall 208. In an embodiment, the recess 402 may be formed by performing one or more machining operations on the casted or forged machine component 200. These machining operations may include turning, or milling, but is not limited thereto. One of ordinary skill in the art will acknowledge that numerous other material removal processes are commonly known in the art and may be suitably implemented in lieu of the machining operations disclosed herein.

At step 806, the method 800 further includes filling the recess 402 with the filler material 502 to the pre-determined thickness T2. At step 808, the method 800 further includes finishing the component 200 by performing at least one machining operation on the filler material 502.

Various embodiments disclosed herein are to be taken in the illustrative and explanatory sense, and should in no way be construed as limiting of the present disclosure. All directional references (e.g., axial, radial, above, below, upper, lower, top, bottom, vertical, horizontal, inward, outward, upward, downward, left, right, leftward, rightward, L.H.S, R.H.S, clockwise, and counter-clockwise) are only used for identification purposes to aid the reader's understanding of the present disclosure, and may not create limitations, particularly as to the position, orientation, or use of the devices and/or methods disclosed herein. Joinder references (e.g., attached, affixed, coupled, engaged, connected, and the like) are to be construed broadly. Moreover, such joinder references do not necessarily infer that two elements are directly connected to each other.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

Embodiments of the present disclosure have applicability for implementation and use in manufacturing and/or salvaging manufactured machine components by minimizing the porosity in the machine components.

With use of conventionally known methods for manufacturing various machine components, for e.g., casting, forging, additive manufacturing and the like; machine components produced therefrom may exhibit porosity. In applications where the components may have to interact with fluids, porosity may adversely affect a performance of such components.

Embodiments of the present disclosure allow manufacturers of machine components to produce the machine components with little or no porosity thereby mitigating operational inefficiencies arising out of porosity. Moreover, the machine components may be rendered leak-proof or with minimal possibility of fluid leakage. The methods 700, 800 disclosed herein allow manufacturers to thus produce various industrially applicable parts or components with minimal effort, costs, and time.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A machine component manufactured using a manufacturing process, the machine component having a wall exhibiting at least some porosity therethrough, the machine component comprising:
a filler material added to the wall at locations that exhibit porosity, the filler material configured to cover the porosity present in the wall, wherein the filler material is added using a laser cladding process.

2. The machine component of claim 1 further including a recess formed at the locations of porosity in the wall, the recess configured to receive with the filler material therein.

3. The machine component of claim 1, wherein the filler material is at least partly finished using a finishing operation to bring the machine component to final dimensional specifications.

4. A method for manufacturing a machine component, the method comprising:
obtaining at least one of a casted component, a forged component, and a component manufactured from use of additive fabrication, the component having a wall exhibiting at least some porosity therethrough;
adding a filler material on the wall to a pre-determined thickness, the filler material configured to cover the porosity present in the wall; and
finishing the machine component by performing a finishing operation.

5. The method of claim 4 further comprising forming a recess in the wall at locations that exhibit porosity, the recess extending partway through a thickness of the wall.

6. The method of claim 5, wherein forming a recess in the wall includes performing a machining operation on an outer surface of the wall to reduce a thickness thereof.

7. The method of claim 5, wherein adding the filler material includes filling the recess with the filler material to the pre-determined thickness.

8. The method of claim 5, wherein the recess is a groove extending partway through the thickness of the wall.

9. The method of claim 4, wherein filling the recess includes performing a laser cladding operation on the recess.

10. The method of claim 4, wherein a type of filler material used is similar to a material of the component.

11. A method of salvaging a component, the method including:
forming the component by at least one of casting, forging, and additive fabrication, the formed component having the wall exhibiting at least some porosity therethrough; and
employing the method of claim 4 to minimize the porosity of the formed component.

12. A machine component manufactured using the method of claim 4.

13. The machine component of claim 12, wherein the machine component is at least one of a swirler of a gas turbine engine and an antenna guide of an aviation vehicle.

14. A gas turbine engine employing the machine component of claim 12.

15. A method for manufacturing a machine component, the method comprising:
forming a component by at least one of casting, forging, and additive fabrication, the formed component having a wall exhibiting at least some porosity therethrough;
forming a recess in the wall at locations that exhibit porosity, the recess extending partway through a thickness of the wall;
filling the recess with a filler material to a pre-determined thickness; and
finishing the component by performing at least one machining operation.

16. The method of claim 15, wherein the recess is a groove extending partway through a thickness of the wall.

17. The method of claim 15, wherein filling the recess includes performing a laser cladding operation on the recess.

18. The method of claim 15, wherein a type of filler material used is similar to a material of the component.

19. A machine component manufactured using the method of claim 15.

20. The machine component of claim 19, wherein the machine component is at least one of a swirler of a gas turbine engine and an antenna guide of an aviation vehicle.
